(19) United States
(12) Patent Application Publication
(10) Pub. No.: US 2011/0127870 A1
(43) Pub. Date: Jun. 2, 2011

(54) ROTOR FOR PERMANENT-MAGNET MOTOR, PERMANENT-MAGNET MOTOR, AND METHODS OF MANUFACTURING THE SAME

(75) Inventors: Hideyuki ONDA, Fukuoka (JP); Kanta Yamaguchi, Fukuoka (JP)

(73) Assignee: KABUSHIKI KAISHA YASKAWA DENKI, Kitakyushu-shi (JP)

(21) Appl. No.: 12/879,017

(22) Filed: Sep. 10, 2010

(30) Foreign Application Priority Data
Dec. 1, 2009 (JP) 2009-273138

(51) Int. Cl. H02K 1/28; H02K 15/03

(52) U.S. Cl. 310/156.12; 29/598

(57) ABSTRACT

A rotor for a permanent-magnet motor includes a rotor-core surface, a plurality of ridges provided on the rotor-core surface and extending in an axial direction of the rotor, a plurality of areas defined by the ridges, and a plurality of permanent magnets provided on the rotor-core surface within the areas and arranged along sidewalls of the ridges, the sidewalls being on one side in a peripheral direction of the rotor.

### CROSS-REFERENCE TO RELATED APPLICATION

The present application claims priority under 35 U.S.C. §119 to Japanese Patent Application No. 2009-273138, filed Dec. 1, 2009. The contents of the application are incorporated herein by reference in their entirety.

### BACKGROUND OF THE INVENTION

1. Field of the Invention

The present invention relates to a rotor for a permanent-magnet motor, a permanent-magnet motor, and methods of manufacturing the same.

2. Discussion of the Background

A rotor of a typical motor includes a stacked core and a plurality of permanent magnets bonded to the stacked core.

As an exemplary method of bonding permanent magnets at regular intervals with high accuracy, Japanese Unexamined Patent Application Publication No. 2007-37288 discloses a method employing a technique of positioning permanent magnets.

The technique of positioning permanent magnets with reference to ridges on the surface of a core and positioning spacers will now be described. The core is a regular decagonal prism. The core has on the surface thereof ten ridges provided at regular intervals and extending along the corners thereof from one end to the other end. Ring-shaped spacers are fitted to the core. Permanent magnets are placed in areas defined by the ridges and the spacers.

### SUMMARY OF THE INVENTION

According to one aspect of the present invention, a rotor for a permanent-magnet motor includes a rotor-core surface, a plurality of ridges provided on the rotor-core surface and extending in an axial direction of the rotor, a plurality of areas defined by the ridges, and a plurality of permanent magnets provided on the rotor-core surface within the areas and arranged along sidewalls of the ridges, the sidewalls being on one side in a peripheral direction of the rotor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a diagram for describing a rotor core of a rotor for a permanent-magnet motor;

FIG. 1B is a diagram for describing the rotor core of the rotor for a permanent-magnet motor;

FIG. 2 is a cross-sectional view of the rotor core in which the round peripheral surface of the rotor core is represented as a flat surface for the convenience of describing the positional relationship of permanent magnets in areas defined on the surface of the rotor core;

FIG. 3A illustrates the difference between the ideal pitch of permanent magnets and the actual pitch of permanent magnets in a state before the permanent magnets are bonded to the rotor core;

FIG. 3B illustrates the difference between the ideal pitch of permanent magnets and the actual pitch of permanent magnets in another state before the permanent magnets are bonded to the rotor core;

FIG. 3C illustrates the difference between the ideal pitch of permanent magnets and the actual pitch of permanent magnets in a state after the permanent magnets are bonded to the rotor core;

FIG. 3D illustrates the difference between the ideal pitch of permanent magnets and the actual pitch of permanent magnets in another state after the permanent magnets are bonded to the rotor core;

FIG. 3E illustrates the difference between the ideal pitch of permanent magnets and the actual pitch of permanent magnets in another state after the permanent magnets are bonded to the rotor core;

FIG. 4 is a cross-sectional view of the rotor core of the rotor for a permanent-magnet motor;

FIG. 5A illustrates a method of positioning permanent magnets by using permanent-magnet-pressing mechanisms; and

FIG. 5B illustrates the method of positioning permanent magnets by using permanent-magnet-pressing mechanisms.

### DETAILED DESCRIPTION OF THE EMBODIMENTS

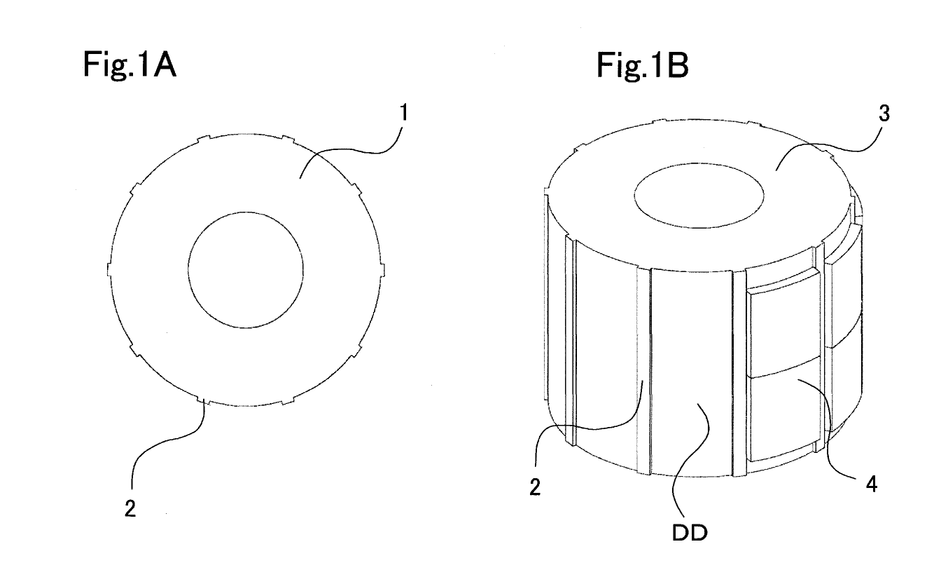

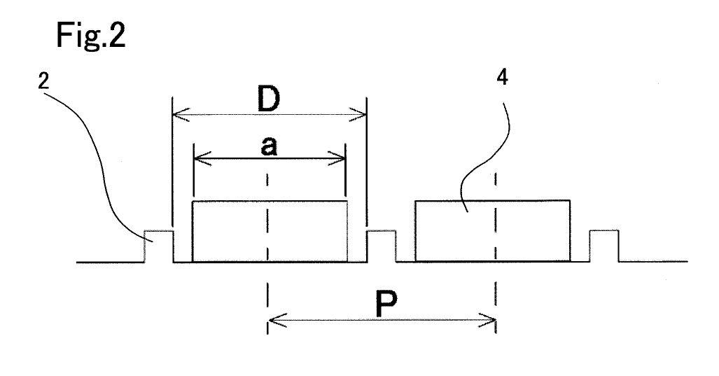

FIGS. 1A and 1B are diagrams for describing a rotor core of a rotor for a permanent-magnet motor according to an embodiment of the present invention. Referring to FIG. 1A, a magnetic steel sheet 1 has projections 2 provided therearound at regular intervals. A plurality of such magnetic steel sheets 1 are stacked, whereby a rotor core 3 shown in FIG. 1B is obtained. A plurality of permanent magnets 4 are placed in areas DD defined by groups of the projections 2, hereinafter referred to as ridges 2.

For the convenience of description, FIG. 2 shows the peripheral surface of the rotor core 3, which is actually round, represented as a flat surface. The average width of the permanent magnets 4 is denoted by a, the dimensional error is denoted by Δa, and the width of each permanent magnet 4 is denoted by a±Δa. To assuredly place the permanent magnets 4 within the areas DD, the dimension (peripheral-direction dimension) D of each area DD is to be expressed as D>a+Δa.

On the basis of FIG. 2, the pitch of permanent magnets 4 is denoted by P, the ideal pitch of permanent magnets 4 is denoted by P_{I}, and the actual pitch of permanent magnets 4 is denoted by P_{R}.

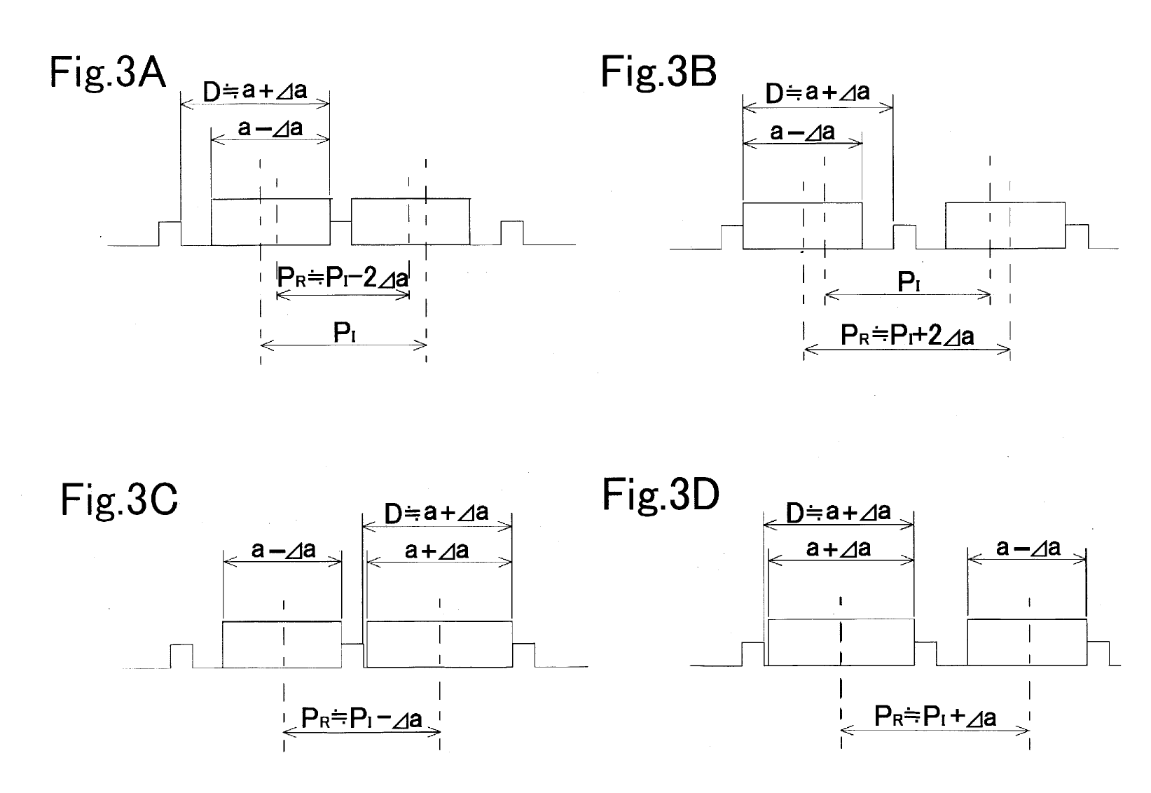

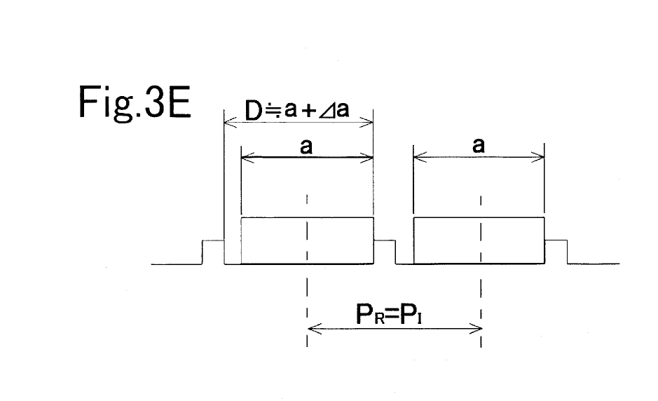

FIGS. 3A to 3E illustrate the difference between the ideal pitch P_{I} of permanent magnets 4 and the actual pitch P_{R} of permanent magnets 4, where the dimension D of the area DD is virtually expressed as D≈a+Δa. In the embodiment, the permanent magnets 4 are positioned along sidewalls, on one side, of the ridges 2 and are bonded to the rotor core 3. FIGS. 3A and 3B show states before the permanent magnets 4 are bonded to the rotor core 3. FIG. 3A shows a state where the actual pitch P_{R} of permanent magnets 4 is the smallest. FIG. 3B shows a state where the actual pitch P_{R} of permanent magnets 4 is the largest.

Considering the states shown in FIGS. 3A and 3B and the dimension D of the area DD expressed as D>a+Δa, the difference between the ideal pitch P_{I} of permanent magnets 4 and the actual pitch P_{R} of permanent magnets 4 in the state before the permanent magnets 4 are positioned along sidewalls, on one side, of the ridges 2 and are bonded to the rotor core 3 falls within a range including the range expressed as −2Δa<P_{I}−P_{R}<2Δa. That is, the pitch of permanent magnets 4 varies within the foregoing range. In addition, before the completion of the bonding of the permanent magnets 4 onto the rotor core 3, the permanent magnets 4 are movable in the peripheral direction within the foregoing range.

FIGS. 3C, 3D, and 3E show states after the permanent magnets 4 are positioned along sidewalls, on one side, of the ridges 2 and are bonded to the rotor core 3. FIG. 3C shows a state where the actual pitch P_{R} of permanent magnets 4 is the smallest. FIG. 3D shows a state where the actual pitch P_{R} of permanent magnets 4 is the largest. FIG. 3E shows a state where the actual pitch P_{R} of permanent magnets 4 is equal to the ideal pitch P_{I} of permanent magnets 4.

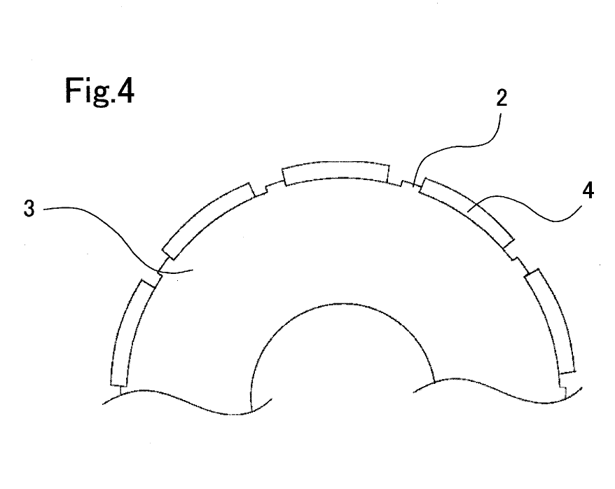

FIG. 4 shows the rotor for a permanent-magnet motor according to the embodiment. As shown in FIG. 4, a plurality of permanent magnets 4 are first positioned along sidewalls, on one side, of the ridges 2 and are subsequently bonded to the rotor core 3. Considering the states shown in FIGS. 3C to 3E and the dimension D of the area DD expressed as D>a+Δa, the range of variations in the pitch of permanent magnets 4 after the above bonding is expressed as −Δa<P_{I}−P_{R}<Δa.

In view of the above, the range of variations in the pitch of permanent magnets 4 after the permanent magnets 4 are positioned along sidewalls, on one side, of the ridges 2 and are bonded to the rotor core 3 is theoretically smaller than or equal to one half of the range of variations in the pitch of permanent magnets 4 before the permanent magnets 4 are positioned along sidewalls, on one side, of the ridges 2 and are bonded to the rotor core 3.

Therefore, by bonding the permanent magnets 4 to the rotor core 3 after positioning the permanent magnets 4 along sidewalls, on one side, of the ridges 2, the permanent magnets 4 can be bonded at regular positions while the dimensional accuracy of the permanent magnets 4 is maintained. That is, by bonding the permanent magnets 4 to the rotor core 3 after positioning the permanent magnets 4 along sidewalls, on one side, of the ridges 2, variations in the pitch of permanent magnets 4 are reduced. Consequently, a rotor having good characteristics in terms of cogging torque and torque ripple is provided.

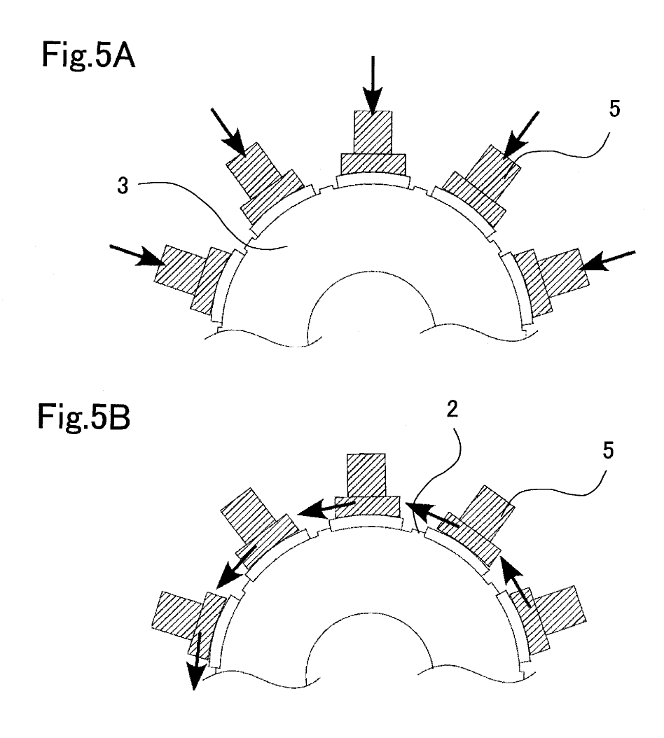

A method of positioning the permanent magnets 4 according to the embodiment will now be described. To position the permanent magnets 4 along sidewalls, on one side, of the ridges 2 and bond the permanent magnets 4 to the rotor core 3 as shown in FIG. 4, permanent-magnet-pressing mechanisms 5 shown in FIGS. 5A and 5B are set on the permanent magnets 4, respectively. While the permanent magnets 4 are pressed by using the permanent-magnet-pressing mechanisms 5 in the directions of the arrows shown in FIG. 5A, forces are applied to the permanent-magnet-pressing mechanisms 5 in the directions of the arrows shown in FIG. 5B until the permanent magnets 4 come into contact with the sidewalls of the ridges 2. In this manner, the permanent magnets 4 are positioned. Desirably, all of the permanent magnets 4 are positioned simultaneously.

If all of the permanent magnets 4 are simultaneously pressed against the sidewalls of the ridges 2 while being pressed against the surface of the rotor core 3 by using the permanent-magnet-pressing mechanisms 5 and are simultaneously bonded to the rotor core 3, the number of steps included in the process of positioning the permanent magnets 4 and the cost of the process are reduced. In addition, since the permanent-magnet-pressing mechanisms 5 can be used repeatedly, increases in costs can be suppressed.

After the permanent magnets 4 are positioned along sidewalls, on one side, of the ridges 2 and are bonded to the rotor core 3 as shown in FIGS. 5A and 5B, the pressing by using the permanent-magnet-pressing mechanisms 5 is stopped. Thus, the permanent magnets 4 are bonded to the rotor core 3 at regular intervals with high accuracy while the dimensional accuracy of the permanent magnets 4 is maintained.

Moreover, since all of the permanent magnets 4 are simultaneously pressed against the sidewalls of the ridges 2 while being pressed against the surface of the rotor core 3 by using the permanent-magnet-pressing mechanisms 5 and are bonded to the rotor core 3, the number of steps included in the process of positioning the permanent magnets 4 and the cost of the process are reduced. In addition, since the permanent-magnet-pressing mechanisms 5 can be used repeatedly, increases in costs can be suppressed.

The embodiment of the present invention has been described as above. It is apparent to those skilled in the art that changes can be made to the embodiment and such changes are also within the technical scope of the present invention.

In the embodiment, while the permanent magnets 4 are pressed by using the permanent-magnet-pressing mechanisms 5, forces are applied to the permanent-magnet-pressing mechanisms 5 in one peripheral direction until the permanent magnets 4 come into contact with the sidewalls of the ridges 2. The present invention is not limited to such a method. Instead of applying forces to the permanent-magnet-pressing mechanisms 5 in one peripheral direction, the rotor core 3 may be rotated in one direction until the permanent magnets 4 come into contact with the sidewalls of the ridges 2 while the permanent magnets 4 are pressed by using the permanent-magnet-pressing mechanisms 5.

In addition, either of the following methods may be employed: a method (whole-body magnetization) in which magnet materials are magnetized after being bonded to a rotor core, and a method (separate magnetization) in which magnet materials are magnetized separately and are subsequently bonded to the rotor core.

If separate magnetization is employed, permanent magnets are attracted to the rotor core when positioned on the rotor core. Therefore, the pressing forces applied by the pressing mechanisms can be removed immediately. If whole-body magnetization is employed, it is desirable to continue, after permanent magnets are positioned, pressing by the pressing mechanisms until the bonding agent is hardened so that the permanent magnets are prevented from moving.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A rotor for a permanent-magnet motor, the rotor comprising:
a rotor-core surface;
a plurality of ridges provided on the rotor-core surface and extending in an axial direction of the rotor;
a plurality of areas defined by the ridges; and
a plurality of permanent magnets provided on the rotor-core surface within the areas and arranged along sidewalls of the ridges, the sidewalls being on one side in a peripheral direction of the rotor.

2. A permanent-magnet motor comprising the rotor for a permanent-magnet motor according to claim 1.

3. A method of manufacturing the rotor for a permanent-magnet motor according to claim 1, the method comprising positioning the permanent magnets in the areas by pressing the permanent magnets against the rotor-core surface and against the sidewalls of the ridges in bonding the permanent magnets onto the rotor-core surface.

4. A method of manufacturing the permanent-magnet motor according to claim 2, the method comprising positioning the permanent magnets in the areas by pressing the permanent magnets against the rotor-core surface and against the sidewalls of the ridges in bonding the permanent magnets onto the rotor-core surface.
